(19) United States
(12) Patent Application Publication
(10) Pub. No.: US 2019/0384098 A1
(43) Pub. Date: Dec. 19, 2019

(54) LIQUID CRYSTAL PANEL AND METHOD FOR MANUFACTURING THE SAME

(71) Applicants: HKC Corporation Limited, Shenzhen City, Guangdong (CN); Chongqing HKC Optoelectronics Technology Corporation Limited, Chongqing (CN)

(72) Inventor: Yu-Jen CHEN, Chongqing (CN)

(21) Appl. No.: 15/550,507

(22) PCT Filed: May 17, 2017
(86) PCT No.: PCT/CN2017/084670

§ 371 Date: Aug. 11, 2017

(30) Foreign Application Priority Data
Apr. 24, 2017 (CN) 201710272092.2

(51) Int. Cl. G02F 1/1335; G02F 1/1339

(52) U.S. Cl. CPC G02F 1/133514; G02F 1/1339

(57) ABSTRACT

This application provides a liquid crystal panel and a method for manufacturing same. The liquid crystal panel includes: a first substrate and a second substrate that are disposed opposite to each other; and a color filter (CF) formed on either of the first substrate and the second substrate, where a block-up color resist layer is formed on a first color resist layer of a plurality of color resist layers that are included in the CF, photo spacers (PSs), including a first PS and a second PS, where the first PS is disposed on the block-up color resist layer, the second PS is disposed on the first color resist layer, and a total height of the first PS and the block-up color resist layer is greater than a height of the second PS; and a fully-filled liquid crystal separation space defined by the PSs between the first substrate and the second substrate.

### BACKGROUND

### Technical Field

This application relates to a manufacturing method, and in particular, to a liquid crystal panel and a method for manufacturing the same.

### Related Art

With progress of science and technologies, liquid crystal displays (LCDs) with a plurality of advantages, such as power saving, no radiation, small volumes, low power consumption, flat squares, high resolution, and stable picture quality, in particular, various current information products, such as mobile phones, notebook computers, digital cameras, PDAs, and liquid crystal screens, are increasingly popular. As a result, demands for liquid crystal displays are greatly increase. Therefore, how to improve manufacturing process efficiency and a product yield is a problem faced by operators.

A liquid crystal display panel mainly includes an active switch array substrate, a color filter (CF) substrate, and liquid crystal molecules filled therebetween. To ensure stable display quality, a photo spacer (PS) needs to be disposed between the active switch array substrate and the CF substrate, so as to maintain a fixed cell gap (CG) between the two substrates.

To improve tolerance of a liquid crystal display panel to an external press, a conventional PS has another design: a dual-step PS design. That is, the PSs are classified into a main photo spacer (main PS) and a sub photo spacer (sub PS). Usually, the main PS implements a supporting function, and the sub PS suspends. The sub PS implements a supporting function only when the liquid crystal display panel is squeezed. A step between the main PS and the sub PS is usually implemented by blocking up an active switch array disposed opposite to the main PS. Therefore, the step between the main PS and the sub PS is a total thickness of a metal layer (M2), a doped semiconductor layer (N+), and a semiconductor layer (a-Si). However, in this design, the step between the main PS and the sub PS is very small. Consequently, a liquid crystal margin (LC margin) of the liquid crystal display panel is relatively small, and mass production benefits are relatively low.

### SUMMARY

To resolve the foregoing technical problem, an objective of this application is to provide a liquid crystal panel and a method for manufacturing same. A step between a main PS and a sub PS of a liquid crystal display panel may be increased without greatly changing an existing manufacturing procedure.

The objective of this application is achieved and a technical problem of this application is resolved by using the following technical solution. A liquid crystal panel provided according to this application comprises: a first substrate; a second substrate, disposed opposite to the first substrate; a CF, formed on either of the first substrate and the second substrate, and comprising a plurality of color resist layers, where the plurality of color resist layers comprises a first color resist layer, and a block-up color resist layer is formed on the first color resist layer; a plurality of PSs, located between the first substrate and the second substrate, and used to define a liquid crystal separation space, where the plurality of PSs comprises a first PS and a second PS, and the first PS is disposed on the block-up color resist layer, and the second PS is disposed on the first color resist layer, and a total height of the first PS and the block-up color resist layer is greater than a height of the second PS; and a liquid crystal layer, located between the first substrate and the second substrate, and fully filling the liquid crystal separation space.

The technical problem of this application may be further resolved in this application by taking the following technical measures.

In an embodiment of this application, the plurality of color resist layers comprises three color resist layers or four color resist layers of different colors.

In an embodiment of this application, when the plurality of color resist layers comprises the three color resist layers of different colors, the first color resist layer is one of a red color resist layer, a blue color resist layer, and a green color resist layer; or when the plurality of color resist layers comprises the four color resist layers of different colors, the first color resist layer is one of a red color resist layer, a blue color resist layer, a green color resist layer, and a white color resist layer.

In an embodiment of this application, a color resist material of the block-up color resist layer and a color resist material of the first color resist layer are different from each other.

In an embodiment of this application, the block-up color resist layer comprises at least one layer of block-up structure, and color resist materials of respective layers of the block-up structure are different from each other.

In an embodiment of this application, the first substrate is an active switch array substrate, the CF is formed on the second substrate, the block-up color resist layer and an active switch of the first substrate are disposed opposite to each other, and the first PS is formed between the block-up color resist layer and the active switch of the first substrate.

In an embodiment of this application, the first substrate is an active switch array substrate, the CF is formed on the first substrate, the second substrate comprises a light shielding layer, the block-up color resist layer and the light shielding layer are disposed opposite to each other, and the first PS is formed between the block-up color resist layer and the light shielding layer.

Another objective of this application is to provide a method for manufacturing a liquid crystal panel, comprising: providing a first substrate and a second substrate that are disposed opposite to each other; forming a CF on either of the first substrate and the second substrate, where the CF comprises a plurality of color resist layers, the plurality of color resist layers comprises a first color resist layer, and a block-up color resist layer is formed on the first color resist layer; forming a plurality of PSs between the first substrate and the second substrate, where the PSs comprise a first PS and a second PS, the plurality of PSs is used to define a liquid crystal separation space, and the first PS is disposed on the block-up color resist layer, and the second PS is disposed on the first color resist layer, and a total height of the first PS and the block-up color resist layer is greater than a height of the second PS; and forming a liquid crystal layer between the first substrate and the second substrate.

The technical problem of this application may be further resolved in this application by taking the following technical measures.

A color resist material of the block-up color resist layer and a color resist material of the first color resist layer are different from each other.

The block-up color resist layer comprises at least one layer of block-up structure, and color resist materials of respective layers of the block-up structure are different from each other.

Still another objective of this application is to provide a liquid crystal panel, comprising: a first substrate; a second substrate, disposed opposite to the first substrate; a CF, comprising a plurality of color resist layers, and formed on either of the first substrate and the second substrate; a plurality of PSs, located between the first substrate and the second substrate, and used to define a liquid crystal separation space; and a liquid crystal layer, located between the first substrate and the second substrate, and fully filling the liquid crystal separation space, where the plurality of color resist layers comprises a first color resist layer, and a block-up color resist layer is formed on the first color resist layer; the plurality of PSs comprises a first PS and a second PS, and the first PS is disposed on the block-up color resist layer, and the second PS is disposed on the first color resist layer, and a total height of the first PS and the block-up color resist layer is greater than a height of the second PS; the block-up color resist layer comprises at least one layer of block-up structure, and color resist materials of respective layers of the block-up structure are different from each other; and the first color resist layer is a red color resist layer, and a color resist material of the block-up color resist layer is the same as a combination of that of a blue color resist layer and that of a green color resist layer.

By means of this application, a step between a main PS and a sub PS of a liquid crystal display panel may be increased without greatly changing an existing manufacturing procedure. Therefore, a liquid crystal margin of the liquid crystal display panel is improved, and a mass production yield is improved.

### BRIEF DESCRIPTION OF THE DRAWINGS

FIG. 1a is a schematic cross-sectional diagram of an exemplary liquid crystal display panel;

FIG. 1b is a schematic cross-sectional diagram of manufacturing of an exemplary liquid crystal display panel;

FIG. 1c is a brief diagram of configuration of a PS step of an exemplary liquid crystal display panel;

FIG. 2a is a schematic cross-sectional diagram of applying a single-layer block-up structure to a liquid crystal display panel according to a method of this application;

FIG. 2b is a schematic cross-sectional diagram of applying a single-layer block-up structure to a liquid crystal display panel according to a method of this application;

FIG. 3 is a schematic cross-sectional diagram of forming a multiple-layer block-up structure applied to a liquid crystal display panel according to a method of this application; and

FIG. 4 is a schematic cross-sectional diagram of forming a composite block-up structure applied to a liquid crystal display panel according to a method of this application.

### DETAILED DESCRIPTION

The following embodiments are described with reference to the accompanying drawings, which are used to exemplify specific embodiments for implementation of this application. Terms about directions mentioned in this application, such as “on”, “below”, “front”, “back”, “left”, “right”, “in”, “out”, and “side surface”, merely refer to directions of the accompanying drawings. Therefore, the used terms about directions are used to describe and understand this application, and are not intended to limit this application.

The accompanying drawings and the description are considered to be essentially illustrative, rather than limitative. In figures, units with similar structures are represented by using a same reference number. In addition, for understanding and ease of description, a size and a thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a substrate is described to be “on” “another component”, the component may be directly on the another component, or there may be an intermediate component.

In addition, in this specification, unless otherwise explicitly described to have an opposite meaning, the word “include” is understood as including the component, but not excluding any other component. In addition, in this specification, “on” means that a component is located on or below a target component, but does not mean that the component needs to be located on top of a gravity direction.

To further describe the technical measures and functions used in the this application for achieving the predetermined objectives, specific implementations, structures, features, and functions of a liquid crystal panel and a method for manufacturing same that are provided in this application are described below in detail with reference to the accompanying drawings and preferred embodiments.

The liquid crystal panel in this application may include: a first substrate, a second substrate, and a liquid crystal layer formed between the two substrates. The first substrate and the second substrate, may be, for example, active switch array (thin film transistors (TFTs) are commonly used in a present process, but this application is not limited thereto) substrates or CF substrates. However, this application is not limited thereto. In an embodiment, alternatively, an active switch array and a CF in this application may be formed on a same substrate.

In an embodiment, a liquid crystal panel in this application may be a curved-surface display panel.

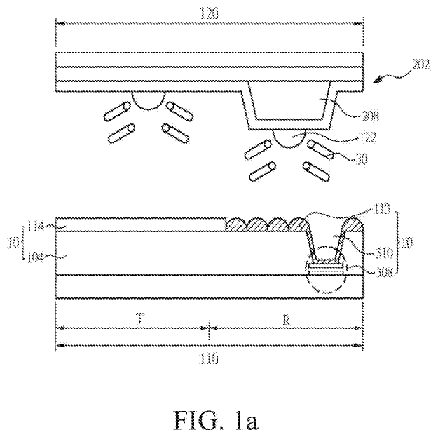

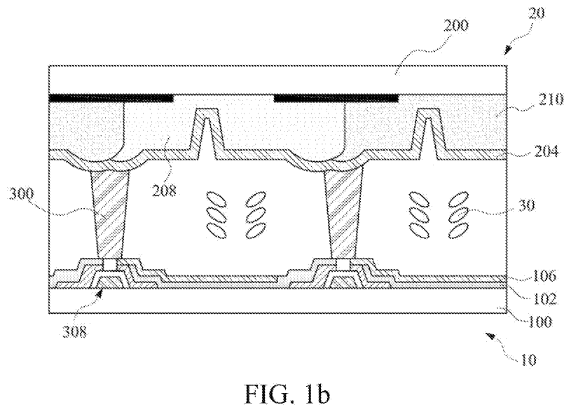

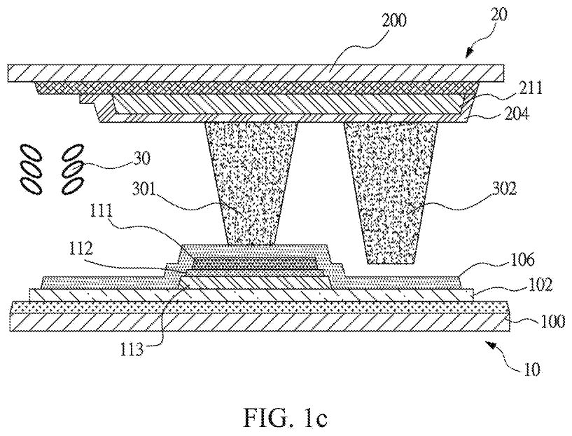

FIG. 1a is a schematic cross-sectional diagram of an exemplary liquid crystal display panel. FIG. 1b is a schematic cross-sectional diagram of manufacturing of an exemplary liquid crystal display panel. FIG. 1c is a brief diagram of configuration of a PS step of an exemplary liquid crystal display panel. Referring to FIG. 1a and FIG. 1b, in development of current liquid crystal display technologies, a dual gap semi-transflective MVA liquid crystal display is used as an example. Usually, in the dual gap semi-transflective liquid crystal display, an adjustment layer 208 is disposed in a reflection area R. As shown in FIG. 1a, the adjustment layer may be disposed on a side of a CF substrate or on a side of a thin film transistor substrate. As shown in FIG. 1a, a basic structure of the dual gap semi-transflective MVA liquid crystal display includes a first substrate 10, a second substrate 20, and a liquid crystal layer 30. The first substrate 10 includes a plurality of pixel areas 110. Each pixel area 110 includes a reflection area R and a transmission area T. The second substrate 20 includes a CF 210. There is also a plurality of pixel areas 120 on the second substrate 20. The pixel areas 120 respectively correspond to the plurality of pixel areas 110 on the first substrate, and each pixel area 120 is provided with an adjustment layer 208 at a position corresponding to the reflection area R. The liquid crystal layer 30 is disposed between the first substrate 10 and the second substrate 20.

Still referring to FIG. 1a, FIG. 1b, and FIG. 1c, each pixel area 110 of the first substrate 10 is provided with an active array switch (a thin film transistor is used as an example, but is not limited thereto) and a storage capacitor 308 under the reflection area R. Subsequently, a planarization layer 104 is formed on an upper surface of the first substrate 10. Then, an uneven surface is made in the reflection area R on the planarization layer 104, and is subsequently plated with metal (such as aluminum or silver) having high reflectivity to serve as a reflective electrode 113. In addition, the transmission area T of each pixel area 110 is also provided with a transparent electrode 114. It is worth mentioning that the reflection area R of each pixel area 110 on the first substrate 10 is further provided with a contact hole 310, used to electrically connect the reflective electrode 113 and the storage capacitor 308. In addition, the CF 210 is further provided with an alignment protrusion 122 (PR for short) at a position relative to the reflection area R and the transmission area T of the first substrate 10. The alignment protrusion 122 changes distribution of electrical power lines, so that liquid crystal molecules tilt toward the alignment protrusion 122 to produce a multi-area liquid crystal alignment (Multi-domains) effect, thereby achieving a wide viewing angle technology, and resolving a problem of gray-scale inversion during single-area liquid crystal alignment (Single-domain). As shown in FIG. 1b, when the first substrate 10 and the second substrate 20 are assembled, the CF 210 is further provided with PSs 300 for fixing a call gap of the panel. A plurality of platforms corresponding to the PSs 300 is designed on a side of the first substrate 10, so that the PSs 300 can keep the cell gap of the panel more stably.

As shown in FIG. 1c, to improve tolerance of the liquid crystal display panel to a press, the PSs 300 are designed as a main PS (main PS) 301 and a sub PS (sub PS) 302. Generally, the main PS 301 implements a supporting function, and the sub PS 302 suspends. The sub PS 302 implements a supporting function only when the liquid crystal display panel is squeezed. A step between the main PS 301 and the sub PS 302 is usually implemented by blocking up an active switch array disposed opposite to the main PS 301. Therefore, the step between the main PS 301 and the sub PS 302 is a total thickness of active switches, including structures such as a metal layer (M2) 111, a doped semiconductor layer (N+) 112, and a semiconductor layer (a-Si) 113. Although the reflective wide-viewing-angle liquid crystal display panel is used as an example for description above, the application scope of this application is not merely limited thereto. This application may be further applied to a dual gap semi-transflective liquid crystal display panel and a single gap semi-transflective liquid crystal display panel.

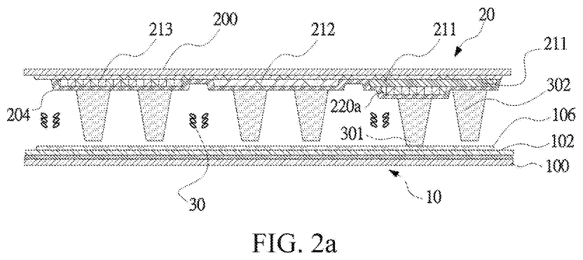

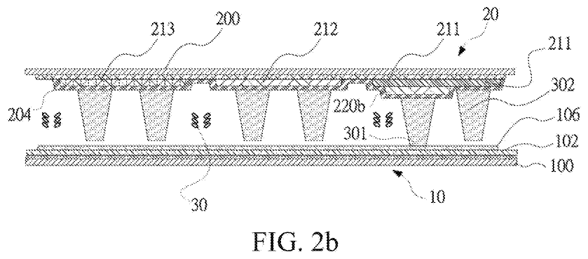

FIG. 2a is a schematic cross-sectional diagram of applying a single-layer block-up structure to a liquid crystal display panel according to a method of this application. Referring to FIG. 2a, in an embodiment of this application, the liquid crystal panel includes: a first substrate 10, including a plurality of pixel areas, where the first substrate 10 includes: a first base 100; a first insulation layer 102, formed on the first base 100; and a first electrode 106, formed on the first insulation layer 102; a second substrate 20, disposed opposite to the first substrate 10, a CF 210, including a plurality of color resist layers, and formed on either of the first substrate 10 and the second substrate 20; a plurality of PSs, located between the first substrate 10 and the second substrate 20, and used to define a liquid crystal separation space, and a liquid crystal layer 30, located between the first substrate 10 and the second substrate 20, and fully filling the liquid crystal separation space.

The plurality of color resist layers includes a first color resist layer 211, a block-up color resist layer 220a is formed on the first color resist layer 211, the plurality of PSs includes a first PS 301 and a second PS 302, and the first PS 301 is disposed on the block-up color resist layer 220a, and the second PS 302 is disposed on the first color resist layer 211, and a total height of the first PS 301 and the block-up color resist layer 220a is greater than a height of the second PS 302, so that a relatively obvious step is formed.

In some embodiments, the second substrate 20 includes: a second base 200, a CF 210, located on the second base 200; and a second electrode 204, located on the CF 210.

In some embodiments, the second substrate 20 further includes a light shielding layer (for example, a black matrix (BM)), approximately located right above the PSs.

In some embodiments, the CF 210 includes the first color resist layer, a second color resist layer, and a third color resist layer whose color resist materials are different from each other, for example, a red color resist layer 211, a green color resist layer 212, and a blue color resist layer 213. The first color resist layer is one of the red color resist layer 211, the blue color resist layer 213, and the green color resist layer 212.

In some embodiments, a color resist material of the block-up color resist layer 220a and a color resist material of the first color resist layer are different from each other. As shown in FIG. 2a, the first color resist layer is the red color resist layer 211, and the color resist material of the block-up color resist layer 220a is the same as that of the blue color resist layer 213.

FIG. 2b is a schematic cross-sectional diagram of applying a single-layer block-up structure to a liquid crystal display panel according to a method of this application. As shown in FIG. 2b, the first color resist layer is the red color resist layer 211, and the color resist material of the block-up color resist layer 220b is the same as that of the green color resist layer 212.

In some embodiments, the first color resist layer is the blue color resist layer 213, and the color resist material of the block-up color resist layer 220b is the same as that of the red color resist layer 211. Alternatively, the first color resist layer is the blue color resist layer 213, and the color resist material of the block-up color resist layer 220b is the same as that of the green color resist layer 212.

In some embodiments, the first color resist layer is the green color resist layer 212, and the color resist material of the block-up color resist layer 220b is the same as that of the red color resist layer 211. Alternatively, the first color resist layer is the green color resist layer 212, and the color resist material of the block-up color resist layer 220b is the same as that of the blue color resist layer 213.

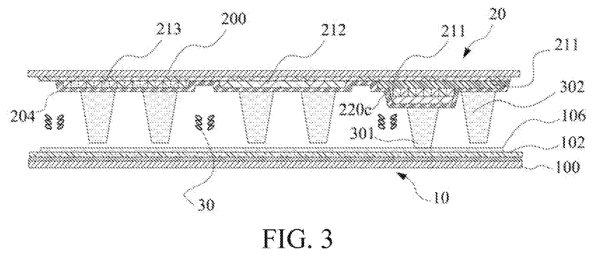

FIG. 3 is a schematic cross-sectional diagram of forming a multiple-layer block-up structure applied to a liquid crystal display panel according to a method of this application. In some embodiments, the block-up color resist layer 220c includes at least one layer of block-up structure, and color resist materials of respective layers of the block-up structure are different from each other. As shown in FIG. 3, the first color resist layer is the red color resist layer 211, and the color resist material of the block-up color resist layer 220c is the same as a combination of that of the blue color resist layer 213 and that of the green color resist layer 212, for example, a combination of blue and green or a combination of green and blue from top to bottom.

In some embodiments, the first color resist layer is the blue color resist layer 213, and the color resist material of the block-up color resist layer 220c is the same as a combination of that of the red color resist layer 211 and that of the green color resist layer 212, for example, a combination of red and green or a combination of green and red from top to bottom.

In some embodiments, the first color resist layer is the green color resist layer 212, and the color resist material of the block-up color resist layer 220c is the same as a combination of that of the red color resist layer 211 and that of the blue color resist layer 213, for example, a combination of red and blue or a combination of blue and red from top to bottom.

In an embodiment, the plurality of color resist layers of the CF 210 may also include, for example, a yellow color resist layer or a color resist layer of another color.

In some embodiments, the CF 210 includes the first color resist layer, a second color resist layer, a third color resist layer, and a fourth color resist layer whose color resist materials are different, for example, the red color resist layer 211, the green color resist layer 212, the blue color resist layer 213, and a white color resist layer. The first color resist layer is one of the red color resist layer 211, the blue color resist layer 213, the green color resist layer 212, and the white color resist layer.

In some embodiments, the color resist material of the block-up color resist layer 220c is different from that of the first color resist layer, but is the same as that of another color resist layer, and may be simultaneously completed in a process of forming the other color resist layer, or may be completed in an additional forming process.

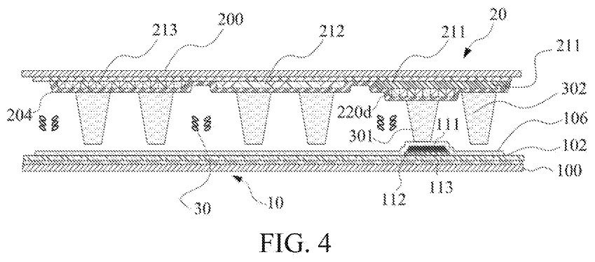

FIG. 4 is a schematic cross-sectional diagram of forming a composite block-up structure applied to a liquid crystal display panel according to a method of this application. In some embodiments, the first substrate 10 is an active switch array substrate, the CF 210 is formed on the second substrate 20, the block-up color resist layer 220d and an active switch of the first substrate 10 are disposed opposite to each other, and the first PS 301 is formed between the block-up color resist layer 220d and the active switch of the first substrate 10. Therefore, a step between the main PS 301 and the sub PS 302 is a total thickness of active switches, including structures such as a metal layer (M2) 111, a doped semiconductor layer (N+) 112, and a semiconductor layer (a-Si) 113, and the block-up color resist layer 220d.

In some embodiments, the first substrate 10 is an active switch array substrate, the CF 210 is formed on the first substrate 10, the second substrate 20 includes a light shielding layer, the block-up color resist layer 220d and the light shielding layer are disposed opposite to each other, and the first PS 301 is formed between the block-up color resist layer 220d and the light shielding layer.

In an embodiment of this application, a method for manufacturing a liquid crystal panel in this application includes: providing a first substrate 10 and a second substrate 20 that are disposed opposite to each other; forming a CF 210 on either of the first substrate 10 and the second substrate 20, where the CF 210 includes a plurality of color resist layers, the plurality of color resist layers includes a first color resist layer, and a block-up color resist layer is formed on the first color resist layer; forming a plurality of PSs between the first substrate 10 and the second substrate 20, where the plurality of PSs is used to define a liquid crystal separation space, and the first PS 301 is disposed on the block-up color resist layer, and the second PS 302 is disposed on the first color resist layer, and a total height of the first PS 301 and the block-up color resist layer is greater than a height of the second PS 302; and forming a liquid crystal layer 30 between the first substrate 10 and the second substrate 20.

By means of this application, the step between the main PS and the sub PS 302 of the liquid crystal display panel may be increased without greatly changing an existing manufacturing procedure. Therefore, a liquid crystal margin of the liquid crystal display panel is improved, and a mass production yield is improved.

Terms such as “in some embodiments” and “in various embodiments” are repeatedly used. Usually, the terms do not refer to a same embodiment; but they may also refer to a same embodiment. Words such as “comprise”, “have”, “include” are synonyms, unless other meanings are indicated in the context.

The foregoing descriptions are merely preferred embodiments of this application, and are not intended to limit this application in any form. Although this application has been disclosed above through the preferred embodiments, the embodiments are not intended to limit this application. Any person skilled in the art can make some equivalent variations or modifications according to the foregoing disclosed technical content without departing from the scope of the technical solutions of this application to obtain equivalent embodiments. Any simple amendment, equivalent change or modification made to the foregoing embodiments according to the technical essence of this application without departing from the content of the technical solutions of this application shall fall within the scope of the technical solutions of this application.

What is claimed is:

1. A liquid crystal panel, comprising:
a first substrate;
a second substrate, disposed opposite to the first substrate;
a color filter (CF), comprising a plurality of color resist layers, and formed on either of the first substrate and the second substrate;
a plurality of photo spacers (PSs), located between the first substrate and the second substrate, and used to define a liquid crystal separation space; and
a liquid crystal layer, located between the first substrate and the second substrate, and fully filling the liquid crystal separation space, wherein
the plurality of color resist layers comprises a first color resist layer, a block-up color resist layer is formed on the first color resist layer, and the plurality of PSs comprises a first PS and a second PS, and the first PS is disposed on the block-up color resist layer, and the second PS is disposed on the first color resist layer, and a total height of the first PS and the block-up color resist layer is greater than a height of the second PS.

2. The liquid crystal panel according to claim 1, wherein the plurality of color resist layers comprises three color resist layers of different colors.

3. The liquid crystal panel according to claim 2, wherein when the plurality of color resist layers comprises the three color resist layers of different colors, the first color resist layer is one of a red color resist layer, a blue color resist layer, and a green color resist layer.

4. The liquid crystal panel according to claim 1, wherein the plurality of color resist layers comprises four color resist layers of different colors.

5. The liquid crystal panel according to claim 4, wherein when the plurality of color resist layers comprises the four color resist layers of different colors, the first color resist layer is one of a red color resist layer, a blue color resist layer, a green color resist layer, and a white color resist layer.

6. The liquid crystal panel according to claim 1, wherein a color resist material of the block-up color resist layer and a color resist material of the first color resist layer are different from each other.

7. The liquid crystal panel according to claim 1, wherein the block-up color resist layer comprises at least one layer of block-up structure.

8. The liquid crystal panel according to claim 7, wherein color resist materials of respective layers of the block-up structure are different from each other.

9. The liquid crystal panel according to claim 1, wherein the first substrate is an active switch array substrate, the CF is formed on the second substrate, the block-up color resist layer and an active switch of the first substrate are disposed opposite to each other, and the first PS is formed between the block-up color resist layer and the active switch of the first substrate.

10. The liquid crystal panel according to claim 1, wherein the first substrate is an active switch array substrate, the CF is formed on the first substrate, the second substrate comprises a light shielding layer, the block-up color resist layer and the light shielding layer are disposed opposite to each other, and the first PS is formed between the block-up color resist layer and the light shielding layer.

11. A method for manufacturing a liquid crystal panel, comprising:
providing a first substrate and a second substrate that are disposed opposite to each other;
forming a color filter (CF) on either of the first substrate and the second substrate, wherein the CF comprises a plurality of color resist layers, the plurality of color resist layers comprises a first color resist layer, and a block-up color resist layer is formed on the first color resist layer;
forming a plurality of photo spacers (PSs) between the first substrate and the second substrate, wherein the PSs comprise a first PS and a second PS, the plurality of PSs is used to define a liquid crystal separation space, and the first PS is disposed on the block-up color resist layer, and the second PS is disposed on the first color resist layer, and a total height of the first PS and the block-up color resist layer is greater than a height of the second PS; and
forming a liquid crystal layer between the first substrate and the second substrate.

12. The method for manufacturing a liquid crystal panel according to claim 11, wherein a color resist material of the block-up color resist layer and a color resist material of the first color resist layer are different from each other.

13. The method for manufacturing a liquid crystal panel according to claim 11, wherein the block-up color resist layer comprises at least one layer of block-up structure.

14. The method for manufacturing a liquid crystal panel according to claim 13, wherein color resist materials of respective layers of the block-up structure are different from each other.

15. A liquid crystal panel, comprising:
a first substrate;
a second substrate, disposed opposite to the first substrate;
a color filter (CF), comprising a plurality of color resist layers, and formed on either of the first substrate and the second substrate;
a plurality of photo spacers (PSs), located between the first substrate and the second substrate, and used to define a liquid crystal separation space; and
a liquid crystal layer, located between the first substrate and the second substrate, and fully filling the liquid crystal separation space, wherein
the plurality of color resist layers comprises a first color resist layer, and a block-up color resist layer is formed on the first color resist layer;
the plurality of PSs comprises a first PS and a second PS, and the first PS is disposed on the block-up color resist layer, and the second PS is disposed on the first color resist layer, and a total height of the first PS and the block-up color resist layer is greater than a height of the second PS;
the block-up color resist layer comprises at least one layer of block-up structure, and color resist materials of respective layers of the block-up structure are different from each other; and
the first color resist layer is a red color resist layer, and a color resist material of the block-up color resist layer is the same as a combination of that of a blue color resist layer and that of a green color resist layer.
